(19) United States
(12) Patent Application Publication
(10) Pub. No.: US 2026/0098718 A1
(43) Pub. Date: Apr. 9, 2026

(54) SYSTEMS AND METHODS FOR INSPECTION AND METROLOGY OF VERTICAL INTERCONNECT ACCESS IN SEMICONDUCTOR SUBSTRATES

(71) Applicant: Orbotech Ltd., Yavne (IL)

(72) Inventors: Nir Turko, Rehovot (IL); John Linden, Modiin (IL); Boaz Rosenberg, Gadera (IL); Lilach Saltoun-Raz, Qiriat Ono (IL)

(21) Appl. No.: 19/299,429

(22) Filed: Aug. 14, 2025

Related U.S. Application Data
(60) Provisional application No. 63/702,659, filed on Oct. 3, 2024.

(51) Int. Cl. G01B 9/02; G01B 9/02015; G01B 9/02091; G01B 11/24; G06T 7/00; G06T 7/55; G06T 7/62

(52) U.S. Cl. CPC G01B 9/02041; G01B 9/0203; G01B 9/02087; G01B 11/2441; G06T 7/0004; G06T 7/55; G06T 7/62; G01B 9/02091; G06T 2207/30148

(57) ABSTRACT

The system includes a light source that emits partially coherent or coherent light split into a reference beam and an object beam and a stage that supports a workpiece in a path of the object beam, that is transmitted through the workpiece. The workpiece includes a vertical interconnect access (VIA) extending from a first side to a second side of the workpiece. A first beam splitter combines the reference beam with the object beam transmitted through the workpiece into a combined beam, and a camera detects the combined beam received. A processor generates an interference image of the workpiece based on the combined beam, determines amplitude and phase information of the object beam based on the interference image, generates a plurality of depth images of the workpiece based on the amplitude and phase information, and determines a critical dimension (CD) of the VIA based on the plurality of depth images.

### CROSS-REFERENCE TO RELATED APPLICATIONS

This application claims priority to the provisional patent application filed Oct. 3, 2024, and assigned U.S. App. No. 63/702,659, the entire disclosure of which is hereby incorporated by reference.

### FIELD OF THE DISCLOSURE

This disclosure relates to semiconductor inspection and metrology systems and, more particularly, to interferometry-based inspection and metrology systems.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a semiconductor workpiece (e.g., wafer, substrate, display panel, etc.) using a large number of fabrication processes to form various features and multiple levels of the semiconductor devices. For example, lithography is a semiconductor fabrication process that involves transferring a pattern from a reticle to a photoresist arranged on a semiconductor workpiece. Additional examples of semiconductor fabrication processes include, but are not limited to, chemical-mechanical polishing (CMP), etch, deposition, and ion implantation. Multiple semiconductor devices may be fabricated in an arrangement on a single semiconductor workpiece that are separated into individual semiconductor devices.

Inspection processes are used at various steps during semiconductor manufacturing to detect defects on workpieces to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Metrology processes are also used at various steps during semiconductor manufacturing to monitor and control the process. Metrology processes are different than inspection processes in that, unlike inspection processes in which defects are detected on workpieces, metrology processes are used to measure one or more characteristics of the workpieces that cannot be determined using existing inspection tools. Metrology processes can be used to measure one or more characteristics of workpieces such that the performance of a process can be determined from the one or more characteristics. For example, metrology processes can measure a dimension (e.g., line width, thickness, etc.) of features formed on the workpieces during the process. In addition, if the one or more characteristics of the workpieces are unacceptable (e.g., out of a predetermined range for the characteristic(s)), the measurements of the one or more characteristics of the workpieces may be used to alter one or more parameters of the process such that additional workpieces manufactured by the process have acceptable characteristic(s).

For some types of workpieces (e.g., those made of glass, silicon, or other transparent materials) and some types of features (e.g., voids, cracks, vertical interconnect access (VIAs), or other material variations), traditional inspections and metrology processes may inadequately detect defects or measure characteristics of the workpiece. Some methods involve using a brightfield microscope to image the top surface of the substrate, refocusing within the substrate to capture the middle plane, and flipping the substrate to image the bottom surface of the substrate. These methods require multiple acquisitions with optical head movement that can be prone to alignment errors and reduce throughput time. Flipping the substrate and refocusing can also introduce alignment and registration errors. Focusing through the substrate may not accurately locate the middle of a VIA, and the short depth of focus can fail to detect critical defects not located in the focused planes.

Therefore, what is needed is an improved inspection and metrology system for detecting defects and measuring characteristics of transparent workpieces and VIAs.

### BRIEF SUMMARY OF THE DISCLOSURE

An embodiment of the present disclosure provides a system. The system may comprise a light source configured to emit partially coherent or coherent light split into a reference beam and an object beam. The system may further comprise a stage configured to support a workpiece in a path of the object beam, such that the object beam is transmitted through the workpiece. The workpiece may include at least one vertical interconnect access (VIA) extending from a first side of the workpiece to a second side of the workpiece. The system may further comprise a first beam splitter configured to combine the reference beam with the object beam transmitted through the workpiece into a combined beam. The system may further comprise a camera configured to detect the combined beam received from the first beam splitter. The system may further comprise a processor in electronic communication with the camera. The processor may be configured to generate an interference image of the workpiece based on the combined beam detected by the camera. The processor may be further configured to determine amplitude and phase information of the object beam based on the interference image. The processor may be further configured to generate, using numerical propagation, a plurality of depth images of the workpiece based on the amplitude and phase information of the object beam. The processor may be further configured to determine a critical dimension (CD) of the at least one VIA based on the plurality of depth images of the workpiece.

In some embodiments, the system may further comprise a second beam splitter configured to split the coherent light from the light source into the reference beam and the object beam.

In some embodiments, the system may further comprise a first fiber optic cable and a second fiber optic cable configured to split the coherent light from the light source into the reference beam and the object beam, respectively.

In some embodiments, the CD of the at least one VIA may comprise a minimum diameter of the at least one VIA in one of the plurality of depth images of the workpiece.

In some embodiments, the plurality of depth images of the workpiece may comprise a first depth image aligned at a depth corresponding to the first side of the workpiece. The plurality of depth images of the workpiece may further comprise a second depth image aligned at a depth corresponding to the second side of the workpiece. The plurality of depth images of the workpiece may further comprise at least one third depth image aligned at a one or more depths between the first side of the workpiece and the second side of the workpiece.

In some embodiments, the processor may be further configured to identify a defect in the workpiece based on the plurality of depth images of the workpiece. In some embodiments, the defect in the workpiece may comprise a crack.

In some embodiments, the system may further comprise a beam steering element configured to adjust an angle of incidence of the object beam on the first side of the workpiece. The processor may be further configured to generate the plurality of depth images of the workpiece at each angle of incidence of the object beam on the first side of the workpiece set by the beam steering element.

In some embodiments, the system may further comprise an electronic storage device in electronic communication with the processor. An AI model may be stored on the electronic storage device. The processor may be configured to generate the plurality of depth images of the workpiece based on the amplitude and phase information of the object beam using the AI model.

In some embodiments, the processor may be further configured to determine the CD of the at least one VIA in each of the plurality of depth images of the workpiece using the AI model.

In some embodiments, the reference beam and the object beam transmitted through the workpiece may be combined off-axis by the first beam splitter.

In some embodiments, the system may further comprise a mirror disposed on the stage beneath the workpiece. The mirror may be configured to reflect the object beam transmitted through the workpiece back through the workpiece to be combined with the reference beam by the first beam splitter.

In some embodiments, the system may further comprise a phase modulator configured to induce a phase shift in the reference beam. In some embodiments, the phase modulator may be further configured to adjust a coherence plane of the reference beam to match that of light going through air or through the workpiece.

In some embodiments, the light source may comprise a first light source and a second light source having different coherence lengths corresponding to light going through air or through the workpiece.

Another embodiment of the present disclosure provides a method. The method may comprise emitting partially coherent or coherent light from a light source. The coherent light may be split into a reference beam and an object beam. The method may further comprise transmitting the object beam through a workpiece supported by a stage. The workpiece may include at least one vertical interconnect access (VIA) extending from a first side of the workpiece to a second side of the workpiece. The method may further comprise combining, with a first beam splitter, the reference beam with the object beam transmitted through the workpiece into a combined beam. The method may further comprise detecting, with a camera, the combined beam received from the first beam splitter. The method may further comprise generating, with a processor, an interference image of the workpiece based on the combined beam detected by the camera. The method may further comprise determining, with the processor, an amplitude and phase information of the object beam based on the interference image. The method may further comprise generating, with the processor, using numerical propagation, a plurality of depth images of the workpiece based on the amplitude and phase information of the object beam. The method may further comprise determining, with the processor, a critical dimension (CD) of the at least one VIA in each of the plurality of depth images of the workpiece.

In some embodiments, generating, with the processor, using numerical propagation, the plurality of depth images of the workpiece based on the amplitude and phase information of the object beam may comprise generating a first depth image aligned at a depth corresponding to the first side of the workpiece, generating a second depth image aligned at a depth corresponding to the second side of the workpiece, and generating at least one third depth image aligned at one or more depths between the first side of the workpiece and the second side of the workpiece.

In some embodiments, the method may further comprise identifying, with the processor, a defect in the workpiece based on the plurality of depth images of the workpiece.

In some embodiments, the method may further comprise moving the stage to align the object beam with the at least one VIA of the workpiece.

In some embodiments, the method may further comprise adjusting, with a beam steering element, an angle of incidence of the object beam on the first side of the workpiece. In some embodiments, generating, with the processor, using numerical propagation, the plurality of depth images of the workpiece based on the amplitude and phase information of the object beam may comprise generating the plurality of depth images of the workpiece at each angle of incidence of the object beam on the first side of the workpiece set by the beam steering element.

In some embodiments, generating, with the processor, using numerical propagation, the plurality of depth images of the workpiece based on the amplitude and phase information of the object beam may comprise generating, with the processor, the plurality of depth images of the workpiece based on the amplitude and phase information of the object beam using an AI model.

In some embodiments, the method may further comprise inducing, with a phase modulator, a phase shift in the reference beam.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a system according to an embodiment of the present disclosure;

FIG. 2 is a diagram of a system according to another embodiment of the present disclosure;

FIG. 3 is a diagram of a system according to another embodiment of the present disclosure;

FIG. 4 is a diagram of a system according to another embodiment of the present disclosure;

FIG. 5 is a diagram of a system according to another embodiment of the present disclosure;

FIG. 6 is a diagram of a system according to another embodiment of the present disclosure;

FIG. 7 is a flowchart of a method according to an embodiment of the present disclosure;

FIG. 8 is a flowchart of a method according to another embodiment of the present disclosure;

FIG. 9 is a flowchart of a method according to another embodiment of the present disclosure;

FIG. 10 is a flowchart of a method according to another embodiment of the present disclosure;

FIG. 11 is a flowchart of a method according to another embodiment of the present disclosure;

FIG. 12 is a flowchart of a method according to another embodiment of the present disclosure; and

FIG. 13 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

An embodiment of the present disclosure provides a system 100. The system 100 may comprise a stage 105 configured to support a workpiece 101. The workpiece 101 may be, for example, a semiconductor wafer, substrate, printed circuit board (PCB), integrated circuit (IC), flat panel display (FPD), or other type of workpiece. The workpiece 101 may be made of transparent or semi-transparent materials, such as glass, silicon, or other materials. The workpiece 101 may include at least one vertical interconnect access (VIA) 104. Each VIA 104 may be a through hole VIA that extends from a first side 102 of the workpiece 101 to a second side 103 of the workpiece 101. Alternatively, each VIA 104 may be a blind VIA that extends from the first side 102 of the workpiece 101 to a depth between the first side 102 and the second side 103 or a buried VIA located between the first side 102 and the second side 103 of the workpiece 101. The workpiece 101 may include other embedded features that have differences in refractive index. The system 100 may be configured to perform one or more inspection or metrology processes on the workpiece 101 supported by the stage 105. The stage 105 may be movable in one or more in-plane directions (e.g., X and Y directions) and/or out of plane direction (e.g., Z direction) to move the workpiece 101. The system 100 may utilize digital holographic microscopy (DHM) and advance AI techniques to perform one or more inspection or metrology processes on the workpiece 101, as further described below.

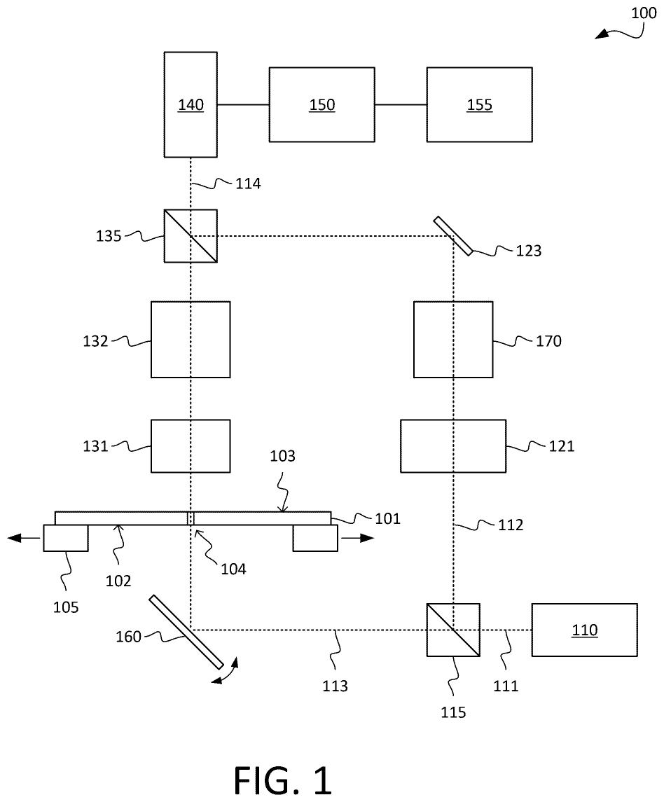

The system 100 may further comprise a light source 110. The light source 110 may be configured to emit partially coherent or coherent light 111, including a reference beam 112 and an object beam 113. In some embodiments, the system 100 may further comprise a second beam splitter 115 configured to split the coherent light 111 from the light source 110 into the reference beam 112 and the object beam 113, as shown in FIG. 1. In some embodiments, the system 100 may further comprise a first fiber optic cable 116 and a second fiber optic cable 117 configured to split the coherent light 111 from the light source 110 into the reference beam 112 and the object beam 113. The wavelength of the coherent light 111 emitted by the light source 110 may depend on the type of workpiece 101 being inspected. For example, visible light (having a wavelength in a range of 400 to 600 nm) may be used for glass substrates, and infrared light (having a wavelength in a range of 900 to 1100 nm) may be used for silicon substrates. The wavelength of the coherent light 111 may vary so long as it is transmissive enough and sensitive enough to the refractive indexes of features of the workpiece 101. In addition, the coherence length of the coherent light 111 may depend on the thickness of the workpiece 101.

The stage 105 may be positioned such that the object beam 113 is transmitted through the workpiece 101. For example, the object beam 113 may be directed at the first side 102 of the workpiece 101 and transmitted through the second side 103 of the workpiece 101. In some embodiments, the stage 105 may be movable to align the object beam 113 with the at least one VIA 104 of the workpiece 101. Accordingly, the object beam 113 may be transmitted through the at least one VIA 104 of the workpiece 101 for inspection of the at least one VIA 104. The stage 105 may be incrementally moved to align with each VIA 104 of the workpiece 101 for separate inspection of each VIA 104 and other features throughout the workpiece 101. In some embodiments, the object beam 113 can be transmitted through part of a large VIA 104, and the stage 105 can be moved to transmit the object beam 113 through another part of the large VIA 104 to be integrated using post-processing. Alternatively, the object beam 113 can be transmitted through several smaller VIAs 104, where there is sufficient image resolution.

The system 100 may further comprise an objective lens 131 disposed in the path of the object beam 113 transmitted through the workpiece 101. The system 100 may further comprise a tube lens 132 in the path of the object beam 113 transmitted through the workpiece 101. The system 100 may further comprise any number of other optical elements disposed in the path of the object beam 113 transmitted through the workpiece 101 and is not limited herein. For example, the system 100 may further comprise diffractive optical elements for phase control and/or a spatial light modulator (SLM) for phase modifications of the object beam 113.

The system 100 may further comprise a first beam splitter 135. The first beam splitter may be configured to combine the reference beam 112 with the object beam 113 transmitted through the workpiece 101 into a combined beam 114.

The system 100 may further comprise a beam expander 121 disposed in the path of the reference beam 112. The system 100 may further comprise a reference mirror 123 disposed in the path of the reference beam 112, which may be configured to direct the reference beam 112 to the first beam splitter 135. The system 100 may further comprise any number of other optical elements disposed in the path of the reference beam 112 and is not limited herein. For example, the system 100 may further comprise a beam expander, collimating optics, diffractive optics for phase uniformity, intensity filters, variable length motion controllers to match the optical path difference changes, and/or polarization rotation elements for optimal interference of the reference beam 112 with the object beam 113.

The system 100 may further comprise a camera 140. The camera 140 may be configured to detect the combined beam 114 received from the first beam splitter 135.

The system 100 may further comprise a processor 150. The processor 150 may include a microprocessor, a microcontroller, field programmable gate array (FPGA), or other devices. The processor 150 may be coupled to the components of the system 100 in any suitable manner (e.g., via one or more transmission media, which may include wired and/or wireless transmission media) such that the processor 150 can receive output. The processor 150 may be configured to perform a number of functions using the output. An inspection tool can receive instructions or other information from the processor 150. The processor 150 optionally may be in electronic communication with another inspection tool, a metrology tool, a repair tool, or a review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the system 100 or another device. In an example, the processor 150 may be part of a standalone control unit or in a centralized quality control unit. Multiple processors 150 may be used, defining multiple subsystems of the system 100.

The processor 150 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 150 to implement various methods and functions may be stored in readable storage media, such as a memory.

If the system 100 includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system 100 or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system 100 or using images or data from other sources.

The processor 150 may be communicatively coupled to any of the various components or sub-systems of system 100 in any manner known in the art. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system 100 may include one or more computing or logic systems. Therefore, the above description should not be interpreted as a limitation on the present disclosure but merely an illustration.

The processor 150 may be in electronic communication with the stage 105. For example, the processor 150 may be configured to send instructions or one or more actuators of the stage 105 to move the stage 105 relative to the object beam 113. For example, the one or more actuators may move the stage 105 (i.e., in the x and y directions) such that the object beam 113 is aligned with one VIA 104 of the workpiece 101. The position of the stage 105 may be adjusted (i.e., in the z direction) based on the thickness of the workpiece 101.

The processor 150 may be in electronic communication with the camera 140. For example, the processor 150 may be configured to receive signals based on the combined beam 114 detected by the camera 140. The processor 150 may be configured to generate an interference image of the workpiece 101 based on the combined beam 114 detected by the camera 140. The processor 150 may be further configured to determine amplitude and phase information of the object beam 113 based on the interference image. The processor 150 may use a filtered backpropagation algorithm to retrieve the amplitude and phase of the object beam 113.

The processor 150 may be further configured to generate, using numerical propagation, a plurality of depth images of the workpiece 101 based on the amplitude and phase information of the object beam 113. For example, the processor 150 may apply the Angular Spectrum or Fresnel Diffraction method to extract amplitude data and determine the specific geometry of each plane to generate the plurality of depth images of the workpiece 101. The processor 150 may be further configured to determine a critical dimension (CD) of the at least one VIA 104 based on the plurality of depth images of the workpiece 101. In some embodiments, the CD of the at least one VIA 104 may comprise a minimum diameter of the at least one VIA 104 in one of the plurality of depth images of the workpiece 101. Alternatively, the CD of the at least one VIA 104 may comprise thickness, top, bottom, and center diameters, ellipticity, taper angle, cracks/bulges, minor and major axes at different depths, curvature through the depth, roughness, anomalies compared to other VIAs, or other measurable features of the at least one VIA 104 from the plurality of depth images of the workpiece 101. The processor 150 may use autofocusing algorithms for speckle/noise reduction and edge detection algorithms (e.g., Canny filtering) to segment each plane, track, and record the CD of the VIA 104 and detect abnormalities in the workpiece 101. Alternatively, the processor 150 may use other segmentation methods that use neural networks (e.g., U-Net, SWIN, etc.). The processor 150 may generate a report of the final CD specifications per VIA 104 per plane.

In some embodiments, the plurality of depth images of the workpiece 101 may comprise a first depth image, a second depth image, and at least one third depth image. The first depth image may be aligned at a depth corresponding to the first side 102 of the workpiece 101. The second depth image may be aligned at a depth corresponding to the second side 103 of the workpiece 101. The at least one third depth image may be aligned at one or more depths between the first side 102 of the workpiece 101 and the second side 103 of the workpiece 101. In an instance, the at least one third depth image may be aligned at a depth that is a midpoint between the first side 102 of the workpiece 101 and the second side 103 of the workpiece 101. The difference in depths between each depth image may vary, depending on the thickness of the workpiece 101. In an instance, the difference in depths between each depth image may range from several μm to tens of μm. The plurality of depth images of the workpiece 101 may therefore resolve internal and transparent structures of the workpiece 101 through digital holography of a single image.

The processor 150 may be further configured to identify a defect in the workpiece 101 based on the plurality of depth images of the workpiece 101. For example, the processor 150 may identify a defect in the workpiece 101 based on the CD of the at least one VIA 104 in each of the plurality of depth images of the workpiece 101. In an instance, a defect in the workpiece 101 may be present where the minimum diameter of the VIA 104 may be less than a minimum threshold. In an instance, the minimum threshold may be, for example, 100μm. Other defects can include surface scratches, embedded cracks, roughness of the VIA 104, high deformation, curvature of the VIA through depth, difference locations of center of symmetry of the top, middle, and bottom of the VIA, or glass thickness. For certain small VIAs (e.g., 2μm diameter), the defect may correspond to the xyz location of the VIA 104.

The system 100 may further comprise an electronic data storage unit 155. The electronic data storage unit may be in electronic communication with the processor 150. An AI model may be stored on the electronic data storage unit 155. The processor 150 may apply AI methods such as CNN and RNN modeling on propagated planes to locate and determine the CD of the VIA 104 or other defects efficiently. For example, the processor 150 may be configured to generate a plurality of depth images of the workpiece 101 based on the amplitude and phase information of the object beam 113 using the AI model. The processor 150 may be further configured to determine a critical dimension (CD) of the at least one VIA 104 in each of the plurality of depth images of the workpiece 101 using the AI model. The processor 150 may be further configured to identify a defect in the workpiece 101 based on the plurality of depth images of the workpiece 101 using the AI model. The AI model may be trained based on the type of workpiece 101 being inspected.

The system 100 may further comprise a beam steering element 160. The beam steering element 160 may be configured to adjust an angle of incidence of the object beam 113 on the first side 102 of the workpiece 101. For example, the beam steering element 160 may ensure normal incidence of the object beam 113 on the first side 102 of the workpiece 101 or may adjust the angle of incidence to one or more oblique angles. Normal incidence may center the main frequency of the interference in the FFT transform relative to the NA frequency limit. The processor 150 may be in electronic communication with the beam steering element 160. For example, the processor 150 may be configured to send instructions to the beam steering element 160 to adjust the angle of incidence of the object beam 113 on the first side 102 of the workpiece 101. The processor 150 may be further configured to generate a plurality of depth images of the workpiece 101 at each angle of incidence of the object beam 113 set by the beam steering element 160 based on the amplitude and phase information of the object beam 113. By acquiring additional images from different incident angles for a partial tomographic approach to reconstruct geometry from multiple angles, 3D reconstruction and resolution of the workpiece 101 can be improved. Accordingly, the processor 150 may be configured to identify additional defects in the workpiece 101 (e.g., scratches or microcracks) or additional defect features (e.g., depth of cracks) that may be identifiable when the angle of incidence is at an oblique angle relative to the first side 102 of the workpiece 101.

In some embodiments, the beam steering element 160 may comprise a fast scanning mirror (FSM). An FSM can rapidly change the angle of a beam by reflecting it off a mirror that can tilt in different directions. When used in conjunction with an infinity-corrected objective, the FSM can focus and scan the beam at the back focal plane, resulting in a collimated beam that can be steered precisely. An FSM can provide high-speed and precise control of the beam angle, making it suitable for dynamic applications.

In some embodiments, the beam steering element 160 may comprise a galvanometer mirror. Similar to FSMs, galvanometer mirrors use rotating mirrors driven by galvanometers to steer the beam. These mirrors can achieve high-speed scanning and are often used in laser scanning systems. These mirrors can also offer fast response times and high precision, suitable for applications requiring rapid beam steering.

In some embodiments, the beam steering element 160 may comprise a liquid crystal spatial light modulator (LC-SLM). LC-SLMs can modulate the phase of the incoming light beam, allowing for dynamic control of the beam direction. By adjusting the phase pattern on the SLM, the beam can be steered to different angles. LC-SLMs can also provide high-resolution control and can be used for complex beam shaping and steering.

In some embodiments, the beam steering element 160 may comprise an acousto-optic deflector (AOD). AODs use sound waves to create a diffraction grating in an acousto-optic material. By changing the frequency of the sound waves, the angle of the diffracted beam can be controlled. AODs can also offer fast and precise beam steering with the ability to control the beam angle electronically.

In some embodiments, the beam steering element 160 may comprise a micro-electro-mechanical system (MEMS) mirror. MEMS mirrors are tiny mirrors that can tilt in multiple directions using electrostatic or electromagnetic forces. These mirrors can be used to steer the beam with high precision. MEMS mirrors can provide compact and low-power solutions for beam steering, suitable for portable and miniaturized systems.

In some embodiments, the beam steering element 160 may comprise an electro-optic beam deflector. These devices use the electro-optic effect to change the refractive index of a material, thereby steering the beam. By applying a voltage, the beam can be deflected to different angles. These devices can offer fast response times and precise control, suitable for high-speed applications.

While several exemplary types of beam steering elements 160 are described herein, each may achieve precise and dynamic control of the beam angle in transmission mode, and the type of beam steering element 160 may be selected depending on the specific application requirements.

The system 100 may further comprise a phase modulator 170. The phase modulator 170 may be configured to induce a phase shift in the reference beam 112. The camera 140 may capture several images of the workpiece 101 with different phase shifts, which may improve the accuracy of phase measurement and reduces noise, making it suitable for quantitative phase imaging.

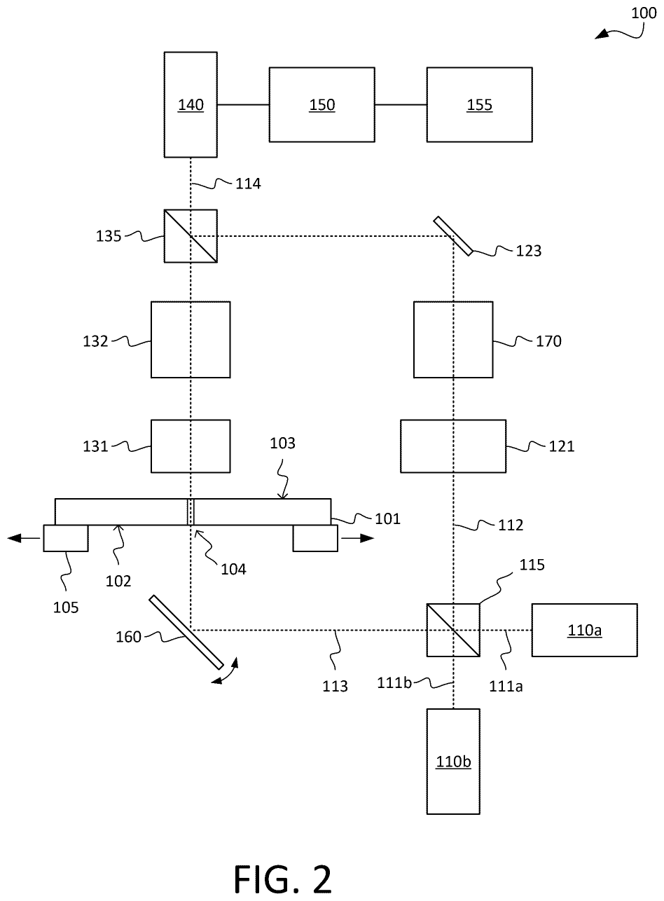

In some embodiments, the phase modulator 170 may be further configured to adjust the coherence plane to match that of light going through air (i.e., the VIA 104) or the workpiece 101. Alternatively, the system 100 may comprise two light sources (e.g., a first light source 110a and a second light source 110b), as shown in FIG. 2, having different coherence lengths (e.g., first light 111a and second light 111b) to quickly adjust the coherence plane by activating either the first light source 110a or the second light source 110b. In either case, it can be controlled whether the combined beam 114 corresponds to light going through the VIA 104 itself or through the workpiece 101, which may be useful in determining the CD of the waist of the VIA 104, in particular, for workpiece 101 with a large thickness.

In some embodiments, the reference beam 112 and the object beam 113 may be aligned along the same optical axis, as shown in FIG. 1 and FIG. 2. The interference pattern may be recorded directly without any angular separation. Numerical methods may be used to separate the real image from the twin image. This may simplify the optical setup and may be suitable for compact and robust systems.

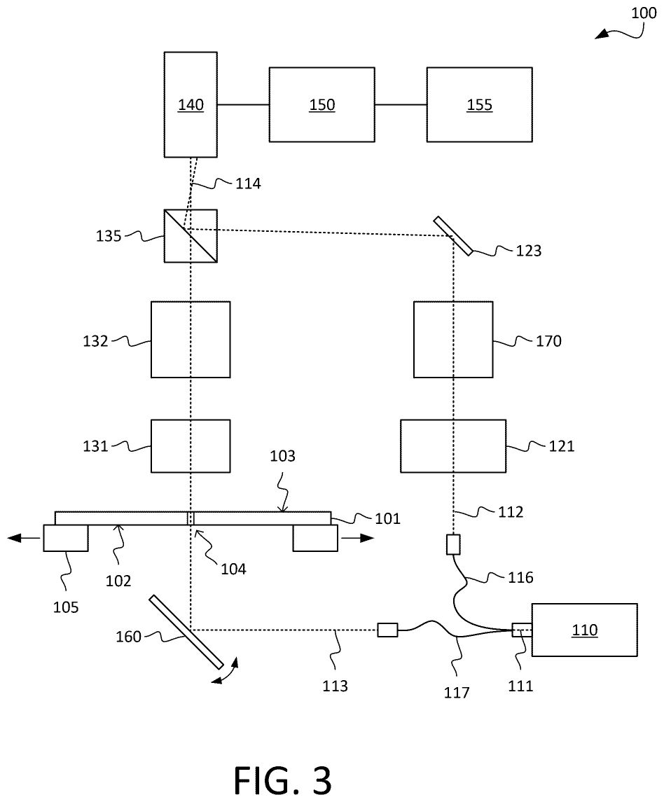

In some embodiments, the reference beam 112 and the object beam 113 may be combined off-axis by the first beam splitter 135 and inclined at a small angle to each other, as shown in FIG. 3. For example, based on the angle of the reference mirror 123 or the arrangement of other optical elements in the path of the reference beam 112, the angle of the reference beam 112 incident on the first beam splitter 135 may produce a combined beam 114 having the reference beam 112 and the object beam 113 that are off-axis. This configuration may allow for the separation of the zero-order and twin image from the real image in the Fourier domain. This may provide high-quality phase and amplitude reconstruction and may be less sensitive to alignment errors.

While FIG. 1 and FIG. 3 are illustrated with on-axis and off-axis alignment of the reference beam 112 and the object beam 113, respectively, each system 100 shown in FIG. 1 and FIG. 3 may be modified to have on-axis or off-axis alignment of the reference beam 112 and the object beam 113, and is not limited by the illustrated examples.

In some embodiments, the system 100 may use telecentric lenses to ensure that the magnification remains constant regardless of the position of the workpiece 101 along the optical axis. This may be beneficial for measuring workpieces 101 with varying heights. This may also provide uniform magnification and reduces optical aberrations, which may be suitable for precise metrology applications.

In some embodiments, the system 100 may use standard lenses, meaning the magnification can vary with the position of the workpiece 101. This configuration may be simpler and less expensive than telecentric systems. This may also be suitable for applications that rely on lower precision and magnification control and can offer flexibility and cost-effectiveness.

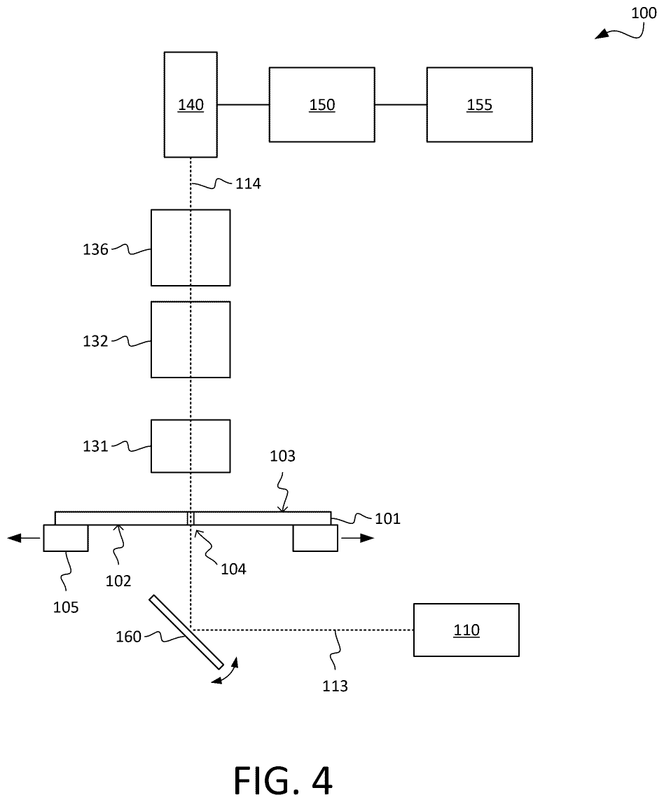

In some embodiments, as illustrated in FIG. 1, the reference beam 112 and the object beam 113 may be parallel beams, with the reference beam 112 taking a beam path that is parallel to the object beam 113 that is combined at the first beam splitter 135. Alternatively, as illustrated in FIG. 4, the light from the light source 110 may not be split into the reference beam 112 and the object beam 113, and instead all of the light may be directed to the workpiece 101 and may share a common path, which minimizes the optical path difference. Then, the light transmitted through the workpiece 101 can be directed to a common-path interferometer module 136, which may split the light into two light beams (one through a spatial filter) and then recombined into the combined beam 114 to enable amplitude and phase demodulation of the two light beams. This configuration may enhance stability and reduce sensitivity to vibrations and environmental changes. This configuration may also be highly stable and compact, which may be suitable for environments with significant external perturbations.

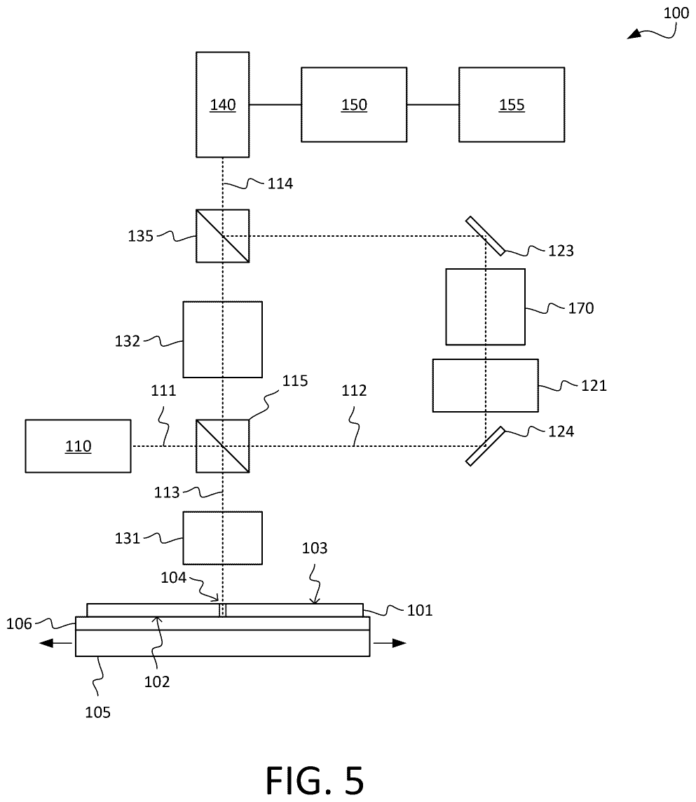

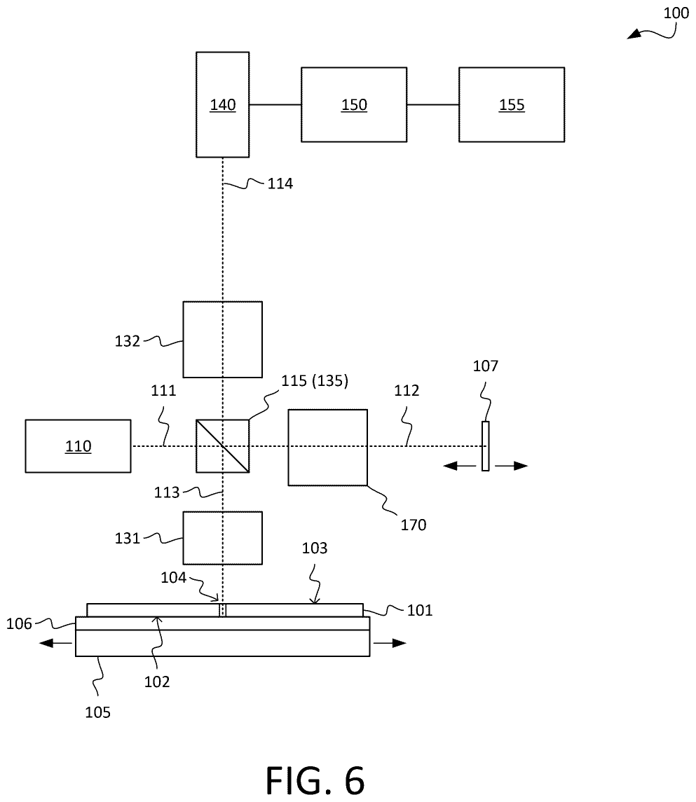

In some embodiments, as illustrated in FIG. 5 and FIG. 6, the second beam splitter 115 may be arranged to direct the object beam 113 toward the second side 103 of the workpiece 101, rather than the first side 102 of the workpiece 101. In this case, a mirror 106 may be provided on the stage 105 beneath the workpiece 101. Accordingly, the object beam 113 transmitted through the at least one VIA 104 of the workpiece 101 may be reflected by the mirror 106 to be transmitted through the workpiece 101 a second time. The reference beam 112 may be directed based on a Mach-Zhander interferometry scheme (as shown in FIG. 5), where a second reference mirror 124 directs the reference beam along a similar path to the embodiments shown in FIG. 1-4 back to the first beam splitter 135. Alternatively, the reference beam 112 may be directed based on a Michelson or Linnik interferometry scheme (as shown in FIG. 6), where the reference beam 112 is reflected by a reference sample 107 back to the second beam splitter 115 or first beam splitter 135 (e.g., a single beam splitter that performs the functions of both the first beam splitter 135 and the second beam splitter 115) to be combined with the object beam 113 reflected by the mirror 106, and the reference sample 107 may be movable to adjust the relative length of the reference arm from the sample arm.

The system 100 may utilize a single plane for reconstruction and a single acquisition per site, which can significantly reduce errors caused by vibrations and the need for realignment of optics and is an improvement over traditional methods that require multiple acquisitions and refocusing, which are prone to errors. By avoiding the need to flip the workpiece 101 and refocus, the system 100 eliminates alignment and registration errors that are common in traditional methods and ensures more accurate and precise measurements of each VIA 104. The system 100 may also be configured to inspect the entire volume of the workpiece 101, not just the focused planes, which can detect critical defects such as cracks, voids, and other abnormalities that might be missed by traditional methods with limited depth of focus. Using numerical propagation methods like the Angular Spectrum or Fresnel Diffraction, the system 100 can accurately reconstruct the geometry of each plane within the workpiece 101, which can provide a detailed and precise depth profile of each VIA 104. The integration of AI methods, such as Convolutional Neural Networks (CNNs) and Recurrent Neural Networks (RNNs), can enhance image quality and analysis capabilities, improve edge detection, track VIA critical dimensions (CD), and identify defects more efficiently than traditional numerical propagation alone. The ability to acquire images from various angles allows for a partial tomographic approach, which improves the 3D reconstruction of features within the workpiece 101 and provides a more comprehensive analysis of the geometry and location of defects.

The system 100 may simplify the inspection process by reducing the number of steps and manual adjustments, which can make the operation more straightforward and less prone to error. The system 100 may also generate detailed reports of the final CD specifications for each VIA 104 at any arbitrary depth, which can provide a clear and comprehensive overview of the quality of the workpiece 101 and any detected defects.

With the system 100, a hologram of the workpiece 101 may be recorded by transmitting coherent light 111 through the workpiece 101 and extracting amplitude and phase through interference with a reference beam 112 (sharing a common path or having a parallel path to the object beam 113), as in interferometry. This may allow numerical propagation of the wave to resolve structures affected during transmission. For example, a full VIA 104 (or several VIAs within the field of view) can be recreated at any depth within the workpiece 101, which can allow measurement of critical dimensions such at a specific middle point of minimal diameter. The system 100 may utilize a single acquisition per VIA site, without needing to refocus or flip the workpiece 101, and can inspect at various angles to separate specific feature geometries and locate defects within the volume of the workpiece 101. For example, the system 100 may be sensitive to cracks and other voids/defects near the VIA 104, regardless of focal plane and location within the volume of the workpiece 101. The system 100 may also utilize AI-driven methods to enhance information and analysis capabilities, including CNNs for image fusion to enhance image quality, edge detection algorithms to track CD of the VIA 104 along the depth, and detect abnormalities for deformed VIAs, cracks, and scratches.

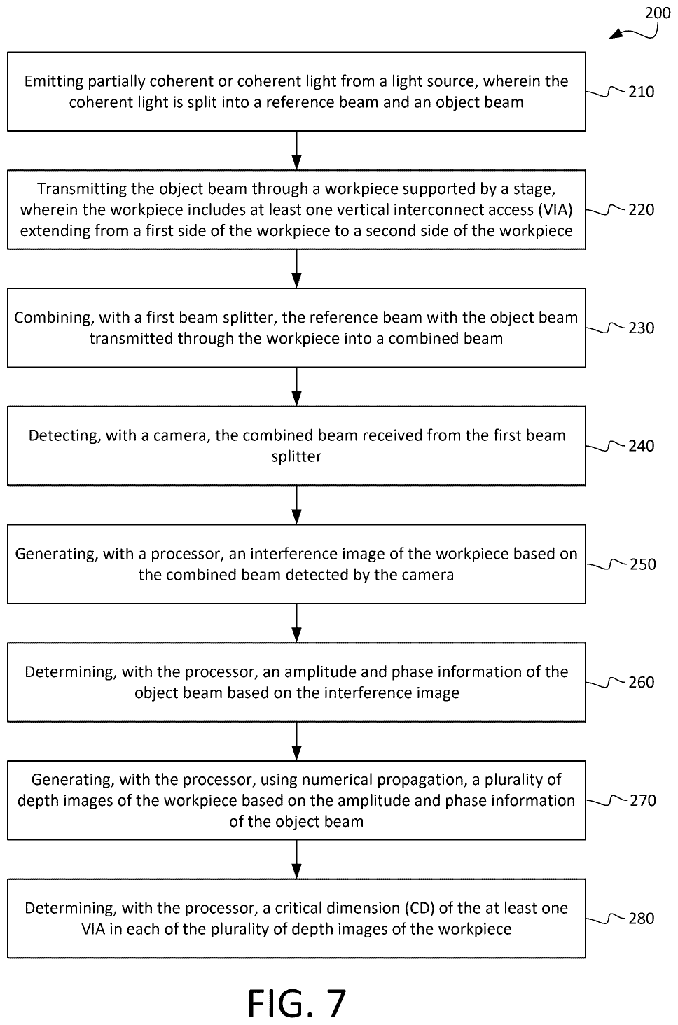

Another embodiment of the present disclosure provides a method 200. As shown in FIG. 7, the method 200 may comprise the following steps.

At step 210, partially coherent or coherent light is emitted from a light source. The light may be split into a reference beam and at least one object beam.

At step 220, the object beam is transmitted through a workpiece supported by a stage. The workpiece includes at least one vertical interconnect access (VIA) extending from a first side of the workpiece to a second side of the workpiece.

At step 230, a first beam splitter combines the reference beam with the object beam transmitted through the workpiece into a combined beam.

At step 240, a camera detects the combined beam received from the first beam splitter.

At step 250, a processor generates an interference image of the workpiece based on the combined beam detected by the camera.

At step 260, the processor determines amplitude and phase information of the object beam based on the interference image.

At step 270, the processor generates, using numerical propagation, a plurality of depth images of the workpiece based on the amplitude and phase information of the object beam.

At step 280, The processor determines a critical dimension (CD) of the at least one VIA in each of the plurality of depth images of the workpiece.

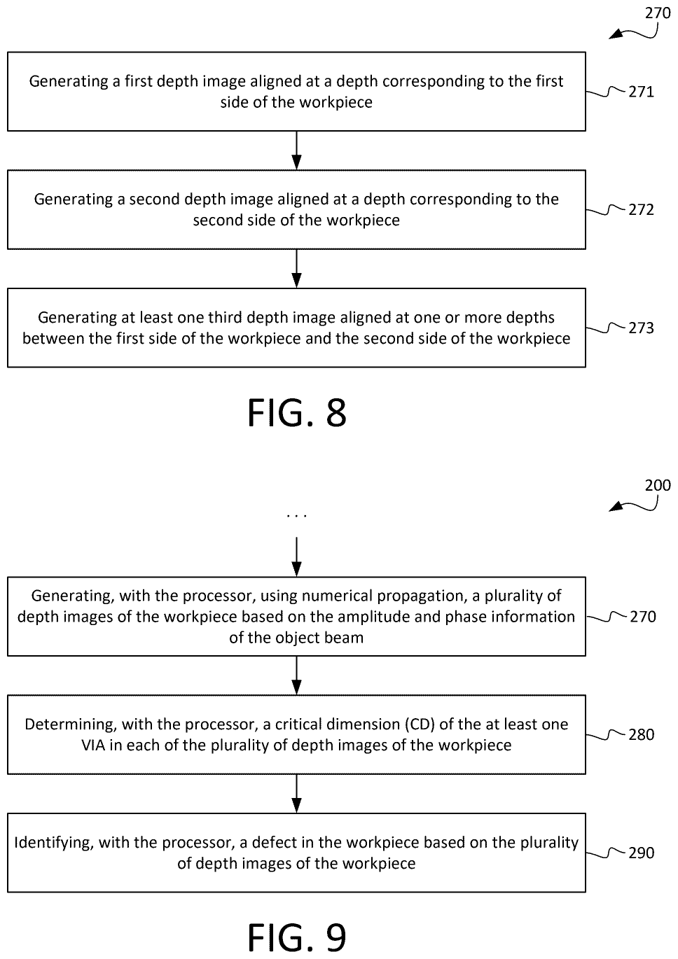

In some embodiments, step 270 may comprise the following steps, as shown in FIG. 8.

At step 271, the processor generates a first depth image aligned at a depth corresponding to the first side of the workpiece.

At step 272, the processor generates a second depth image aligned at a depth corresponding to the second side of the workpiece.

At step 273, the processor generates at least one third depth image aligned at one or more depths between the first side of the workpiece and the second side of the workpiece.

In some embodiments, the method 200 may further comprise step 290, as shown in FIG. 9. At step 290, the processor identifies a defect in the workpiece based on the plurality of depth images of the workpiece. For example, the processor may identify a defect in the workpiece based on the CD of the at least one VIA in each of the plurality of depth images of the workpiece or other measurements of the at least one VIA determined from the plurality of depth images of the workpiece. Accordingly, step 290 may be performed after step 280.

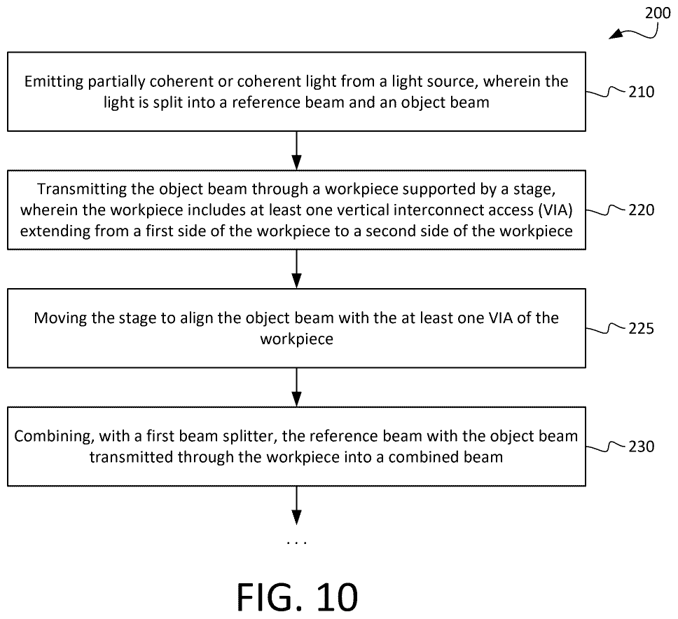

In some embodiments, the method 200 may further comprise step 225, as shown in FIG. 10. At step 225, the stage is moved to align the object beam with the at least one VIA of the workpiece. Step 225 may be performed between steps 220 and 230.

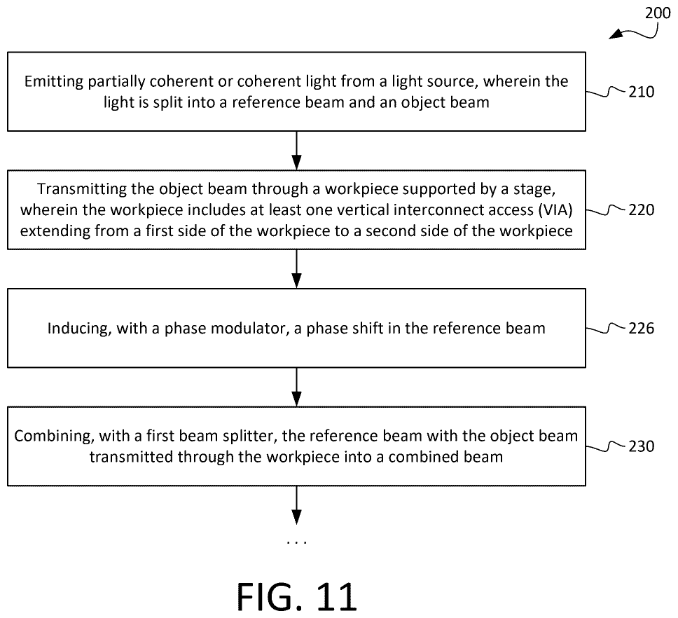

In some embodiments, the method 200 may further comprise step 226, as shown in FIG. 11. At step 226, a phase modulator induces a phase shift in the reference beam. Step 226 may be performed between steps 210 and 230.

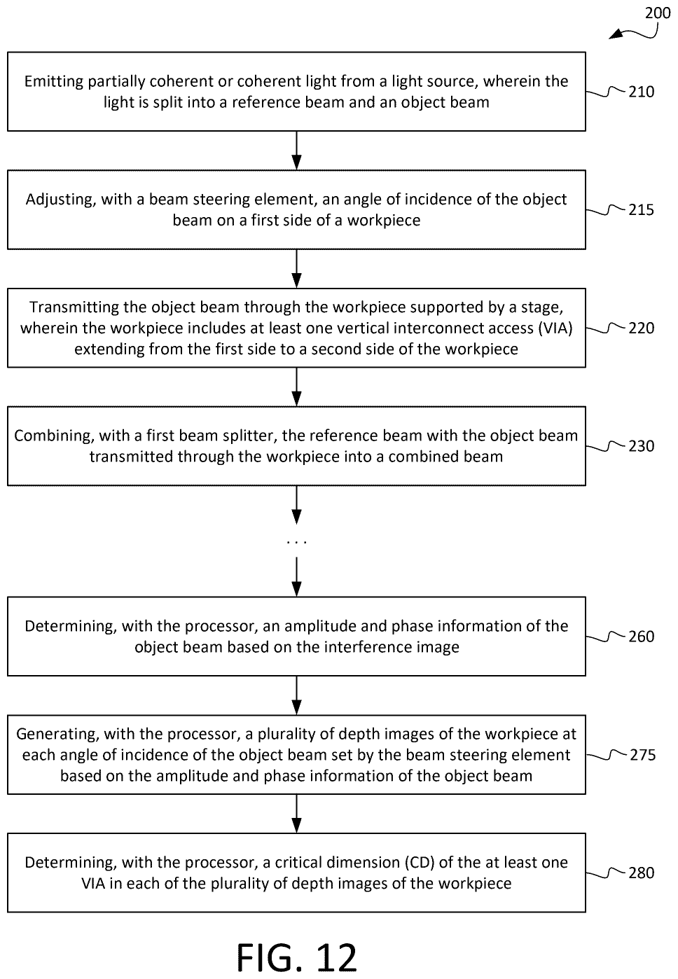

In some embodiments, the method 200 may further comprise step 215 and step 270 may comprise step 275, as shown in FIG. 12. At step 215, a beam steering element adjusts an angle of incidence of the object beam on the first side of the workpiece. At step 275, the processor generates a plurality of depth images of the workpiece at each angle of incidence of the object beam set by the beam steering element based on the amplitude and phase information of the object beam.

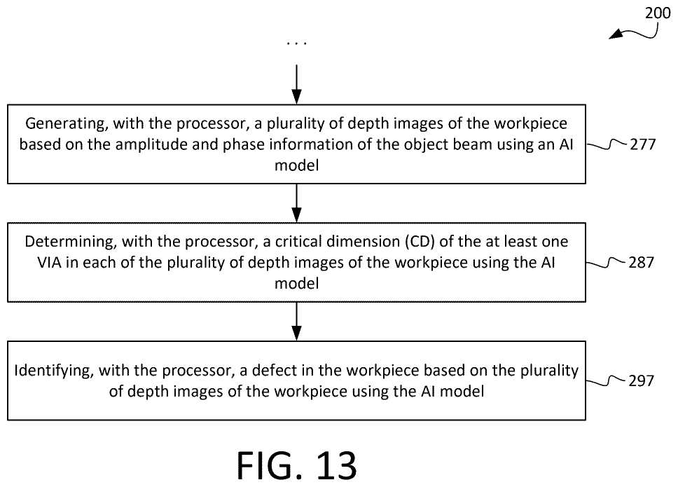

In some embodiments, steps 270-290 may comprise the following steps, as shown in FIG. 13.

At step 277, the processor generates a plurality of depth images of the workpiece based on the amplitude and phase information of the object beam using an AI model.

At step 287, the processor determines a critical dimension (CD) of the at least one VIA in each of the plurality of depth images of the workpiece using the AI model.

At step 297, the processor identifies a defect in the workpiece based on the plurality of depth images of the workpiece using the AI model.

With the method 200, a hologram of the workpiece may be recorded by transmitting coherent light through the workpiece and extracting amplitude and phase through interference with a reference beam (sharing a common path or having a parallel path to the object beam), as in interferometry. This may allow numerical propagation of the wave to resolve structures affected during transmission. For example, a full VIA (or several VIAs within the field of view) can be recreated at any depth within the workpiece, which can allow measurement of critical dimensions such at a specific middle point of minimal diameter. The method 200 may utilize a single acquisition per VIA site, without needing to refocus or flip the workpiece, and can inspect at various angles to separate specific feature geometries and locate defects within the volume of the workpiece. For example, the method 200 may be sensitive to cracks and other voids/defects near the VIA, regardless of focal plane and location within the volume of the workpiece. The method 200 may also utilize AI-driven methods to enhance information and analysis capabilities, including CNNs for image fusion to enhance image quality, edge detection algorithms to track CD of the VIA along the depth, and detect abnormalities for deformed VIAs, cracks, and scratches.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

The AI models described herein may be deep learning models. Rooted in neural network technology, deep learning is a probabilistic graph model with many neuron layers, commonly known as a deep architecture. Deep learning technology processes the information such as image, text, voice, and so on in a hierarchical manner. In using deep learning in the present disclosure, feature extraction is accomplished automatically using learning from data. For example, defects can be classified, sorted, or binned using the deep learning classification module based on the one or more extracted features.

Generally speaking, deep learning (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a deep network, there are many layers between the input and output, allowing the algorithm to use multiple processing layers, composed of multiple linear and non-linear transformations.

Deep learning is part of a broader family of machine learning methods based on learning representations of data. An observation (e.g., a feature to be extracted for reference) can be represented in many ways such as a vector of intensity values per pixel or in a more abstract way like a set of edges, regions of particular shape, etc. Some representations are better than others at simplifying the learning task (e.g., face recognition or facial expression recognition). Deep learning can provide efficient algorithms for unsupervised or semi-supervised feature learning and hierarchical feature extraction.

In an embodiment, the deep learning models of the AI models of the present disclosure may be configured as neural networks. In a further embodiment, the deep learning models may be deep neural networks with a set of weights that model the world according to the data that it has been fed to train it. Neural networks can be generally defined as a computational approach based on a relatively large collection of neural units loosely modeling the way a biological brain solves problems with relatively large clusters of biological neurons connected by axons. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Neural networks typically include multiple layers, and the signal path traverses from front to back. The goal of the neural network is to solve problems in the same way that the human brain would, although several neural networks are much more abstract. Modern neural network projects typically work with a few thousand to a few million neural units and millions of connections. The neural network may have any suitable architecture and/or configuration known in the art.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a light source configured to emit partially coherent or coherent light split into a reference beam and an object beam;
a stage configured to support a workpiece in a path of the object beam, such that the object beam is transmitted through the workpiece, wherein the workpiece includes at least one vertical interconnect access (VIA) extending from a first side of the workpiece to a second side of the workpiece;
a first beam splitter configured to combine the reference beam with the object beam transmitted through the workpiece into a combined beam;
a camera configured to detect the combined beam received from the first beam splitter; and
a processor in electronic communication with the camera, wherein the processor is configured to:
generate an interference image of the workpiece based on the combined beam detected by the camera;
determine amplitude and phase information of the object beam based on the interference image;
generate, using numerical propagation, a plurality of depth images of the workpiece based on the amplitude and phase information of the object beam; and
determine a critical dimension (CD) of the at least one VIA based on the plurality of depth images of the workpiece.

2. The system of claim 1, further comprising:
a second beam splitter configured to split the coherent light from the light source into the reference beam and the object beam.

3. The system of claim 1, further comprising:
a first fiber optic cable and a second fiber optic cable configured to split the coherent light from the light source into the reference beam and the object beam, respectively.

4. The system of claim 1, wherein the CD of the at least one VIA comprises a minimum diameter of the at least one VIA in one of the plurality of depth images of the workpiece.

5. The system of claim 1, wherein the plurality of depth images of the workpiece comprises:
a first depth image aligned at a depth corresponding to the first side of the workpiece;
a second depth image aligned at a depth corresponding to the second side of the workpiece; and
at least one third depth image aligned at a one or more depths between the first side of the workpiece and the second side of the workpiece.

6. The system of claim 1, wherein the processor is further configured to identify a defect in the workpiece based on the plurality of depth images of the workpiece.

7. The system of claim 6, wherein the defect in the workpiece comprises a crack.

8. The system of claim 1, further comprising:
a beam steering element configured to adjust an angle of incidence of the object beam on the first side of the workpiece;
wherein the processor is further configured to generate the plurality of depth images of the workpiece at each angle of incidence of the object beam on the first side of the workpiece set by the beam steering element.

9. The system of claim 1, further comprising:
an electronic storage device in electronic communication with the processor, wherein an AI model is stored on the electronic storage device, and the processor is configured to generate the plurality of depth images of the workpiece based on the amplitude and phase information of the object beam using the AI model.

10. The system of claim 9, wherein the processor is further configured to determine the CD of the at least one VIA in each of the plurality of depth images of the workpiece using the AI model.

11. The system of claim 1, wherein the reference beam and the object beam transmitted through the workpiece are combined off-axis by the first beam splitter.

12. The system of claim 1, further comprising:
a mirror disposed on the stage beneath the workpiece, wherein the mirror is configured to reflect the object beam transmitted through the workpiece back through the workpiece to be combined with the reference beam by the first beam splitter.

13. The system of claim 1, further comprising:
a phase modulator configured to induce a phase shift in the reference beam.

14. The system of claim 13, wherein the phase modulator is further configured to adjust a coherence plane of the reference beam to match that of light going through air or through the workpiece.

15. The system of claim 1, wherein the light source comprises a first light source and a second light source having different coherence lengths corresponding to light going through air or through the workpiece.

16. A method comprising:
emitting partially coherent or coherent light from a light source, wherein the coherent light is split into a reference beam and an object beam;
transmitting the object beam through a workpiece supported by a stage, wherein the workpiece includes at least one vertical interconnect access (VIA) extending from a first side of the workpiece to a second side of the workpiece;
combining, with a first beam splitter, the reference beam with the object beam transmitted through the workpiece into a combined beam;
detecting, with a camera, the combined beam received from the first beam splitter;
generating, with a processor, an interference image of the workpiece based on the combined beam detected by the camera;
determining, with the processor, an amplitude and phase information of the object beam based on the interference image;
generating, with the processor, using numerical propagation, a plurality of depth images of the workpiece based on the amplitude and phase information of the object beam; and
determining, with the processor, a critical dimension (CD) of the at least one VIA in each of the plurality of depth images of the workpiece.

17. The method of claim 16, wherein generating, with the processor, using numerical propagation, the plurality of depth images of the workpiece based on the amplitude and phase information of the object beam comprises:
generating a first depth image aligned at a depth corresponding to the first side of the workpiece;
generating a second depth image aligned at a depth corresponding to the second side of the workpiece; and
generating at least one third depth image aligned at one or more depths between the first side of the workpiece and the second side of the workpiece.

18. The method of claim 16, further comprising:
identifying, with the processor, a defect in the workpiece based on the plurality of depth images of the workpiece.

19. The method of claim 16, further comprising:
moving the stage to align the object beam with the at least one VIA of the workpiece.

20. The method of claim 16, further comprising:
adjusting, with a beam steering element, an angle of incidence of the object beam on the first side of the workpiece; and
wherein generating, with the processor, using numerical propagation, the plurality of depth images of the workpiece based on the amplitude and phase information of the object beam comprises:
generating the plurality of depth images of the workpiece at each angle of incidence of the object beam on the first side of the workpiece set by the beam steering element.

21. The method of claim 16, wherein generating, with the processor, using numerical propagation, the plurality of depth images of the workpiece based on the amplitude and phase information of the object beam comprises:
generating, with the processor, the plurality of depth images of the workpiece based on the amplitude and phase information of the object beam using an AI model.

22. The method of claim 16, further comprising:
inducing, with a phase modulator, a phase shift in the reference beam.
